(19) United States
(12) Patent Application Publication
(10) Pub. No.: US 2006/0050997 A1
(43) Pub. Date: Mar. 9, 2006

(54) Camera device with movie capture function

(75) Inventor: Keiichi Imamura, Hamura-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/220,863

(22) Filed: Sep. 7, 2005

(30) Foreign Application Priority Data
Sep. 9, 2004 (JP) 2004-261798

(51) Int. Cl. G06K 9/20

(52) U.S. Cl. 382/312

(57) ABSTRACT

A camera device comprises a capture unit which captures a subject and outputs moving image data, a recording unit which records the moving image data, an instructing unit which instructs recording of the moving image data into the recording unit, a specifying unit which specifies a first capturing time and a second capturing time, a first recording controller which, when recording is instructed, records first moving image data output from the capturing unit into the recording unit during the first capturing time immediately before recording is instructed, and a second recording controller which, when recording is instructed, records second moving image data output from the capturing unit into the recording unit during the second capturing time immediately after recording is instructed.

### CROSS-REFERENCE TO RELATED APPLICATIONS

This application is based upon and claims the benefit of priority from prior Japanese Patent Application No. 2004-261798, filed Sep. 9, 2004, the entire contents of which are incorporated herein by reference.

### BACKGROUND OF THE INVENTION

1. Field of the Invention

The present invention relates to a camera device with movie capture function and a method of capturing movie which can be used in a digital camera having movie capture function.

2. Description of the Related Art

Conventionally, many of the digital cameras for capturing a still picture with an image pickup device such as, a CCD or a CMOS sensor and recording the same are equipped with movie capture function, and Motion JPEG (Joint Photographic Experts Group), MPEG (Moving Picture Experts Group) and the like are used as a data format for recording a captured movie as a file. With regards to such a movie capture function, as is well known, a function in which the capturing (recording) of a movie starts when a shutter key is pushed and the capturing terminates when the shutter key is pushed again, and a function in which capturing continues while a shutter key is kept to be pushed down and the capturing terminates when the shutter key is released are common.

In another digital camera, a moving image for a certain time of around the time a shutter key is pushed is recorded. In such a technique, the most recent moving images (a plurality of continuing still pictures) captured at a constant interval for a certain time are sequentially updated and stored in a semiconductor memory while displaying a through image before the shutter key is pushed. Storage of the moving images in the semiconductor memory is continued over a certain time immediately after the capturing operation by the shutter is performed.

### BRIEF SUMMARY OF THE INVENTION

The present invention is directed to method and apparatus that substantially obviates one or more of the problems due to limitations and disadvantages of the related art.

According to an embodiment of the present invention, a camera device comprises means for capturing a subject and outputting moving image data; means for recording the moving image data output from the capturing means; instructing means for instructing recording of the moving image data output from the capturing means into the recording means; means for specifying a first capturing time and a second capturing time by manual operation; first recording control means for, when the instructing means instructs recording, recording first moving image data output from the capturing means into the recording means during the first capturing time specified by the specifying means immediately before the recording instructing means instructs recording; and second recording control means for, when the instructing means instructs recording, recording second moving image data output from the capturing means into the recording means during the second capturing time specified by the specifying means immediately after the instructing means instructs recording.

According to another embodiment of the present invention, a method of capturing moving image data in a camera device comprising a capturing unit which captures a subject and outputs moving image data and a recording unit which records the moving image data output from the capturing unit, the method comprises the steps of specifying a first capturing time and a second capturing time by manual operation; instructing recording of the moving image data output from the capturing unit into the recording unit; and when recording is instructed, recording first moving image data output from the capturing unit into the recording unit during the first capturing time immediately before the recording is instructed and recording second moving image data output from the capturing unit into the recording unit during the second capturing time immediately after the recording is instructed.

According to another embodiment of the present invention, a program for causing a computer of a camera device comprising a capturing unit which captures a subject and outputs moving image data and a recording unit which records the moving image data output from the capturing unit, the program causes the computer to execute processings of specifying a first capturing time and a second capturing time by manual operation; instructing recording of the moving image data output from the capturing unit into the recording unit; when recording is instructed, recording first moving image data output from the capturing unit into the recording unit during the first capturing time immediately before the recording is instructed; and when recording is instructed, recording second moving image data output from the capturing unit into the recording unit during the second capturing time immediately after the recording is instructed.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram of a digital camera common to each embodiment according to the present invention;

FIG. 2 is a schematic diagram showing a data storage region in a built-in memory when a PAST movie capture mode is set in a first embodiment of the present invention;

FIG. 3 is a flow chart showing the operation by a capturing time set-up mode according to the embodiment;

FIG. 4 is a view showing an example of a capturing time set-up screen displayed in the capturing time set-up mode;

FIG. 5 is a flow chart showing the operation by a PAST movie capture mode according to the embodiment; and

FIG. 6 is a flow chart showing the operation by a PAST movie capture mode according to a second embodiment of the present invention.

### DETAILED DESCRIPTION OF THE INVENTION

An embodiment of a camera device according to the present invention will now be described with reference to the accompanying drawings.

### First Embodiment

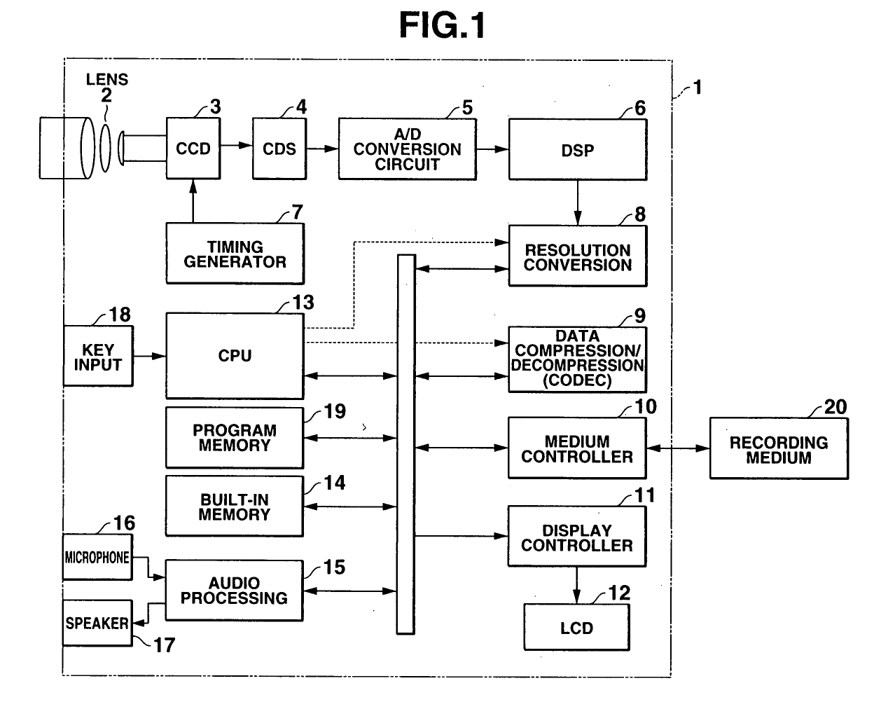

FIG. 1 is a block diagram of a digital camera common to each embodiment of the present invention. The digital camera includes, as a capture mode, a PAST movie capture mode for allowing simultaneous capturing of a still image and a moving image in addition to a still picture capture mode and a movie capture mode.

The digital camera comprises a camera main body 1 and a recording medium 20 which is attachable to and removable from the camera main body 1. The camera main body 1 includes an optical system 2 composed of a plurality of lenses, and a CCD 3 attached with a color filter of Bayer array and the like serving as image capture means having a light receiving surface where an optical image of a subject is captured through the optical system 2. The CCD 3, driven by a driving signal transmitted from a timing generator 7, photoelectric converts the optical image of the subject and outputs the same as an imaging signal. The output signal from the CCD 3 is subjected to correlation double sampling and gain adjustment in a CDS (correlation double sampling) circuit 4, and is converted to a digital signal by an A/D (analog-to-digital) conversion circuit 5. The A/D converted Bayer data is input to a DSP (digital signal processing) unit 6 and subjected to pedestal clamp and the like, and is then converted to a luminance (Y) signal and color difference (UV) signal by a luminance/color difference matrix circuit in the DSP unit 6. In the DSP unit 6, processes for enhancing the quality of the image, such as, auto-iris, auto-white balance, and contour emphasis are performed.

After the YUV data converted by the DSP unit 6 is converted to a preset image size by a resolution conversion block 8, the data for one frame is sequentially stored in a built-in memory 14 (for example, SDRAM). The YUV data for one frame stored in the built-in memory 14 is transferred to a display controller 11 and converted to a video signal therein, and is then displayed as a through image by a liquid crystal display (LCD) 12.

The YUV data stored in the built-in memory 14 is sequentially transferred to a data compression/decompression block 9 during movie capture, encoded after data compression by a CODEC of a predetermined moving image recording method (for example, Motion-JPEG or MPEG), and then sequentially stored in the recording medium 20 as frame data (video data) via the built-in memory 14 and a medium controller 10. The series of operation is repeatedly performed for every frame, and the YUV data (compression data) in the built-in memory 14 is sequentially updated. That is, it is stream recorded. The frame rate at this time is determined by a timing signal generated in the timing generator 7, and the compression rate of the data to be encoded is determined by a quantization table value in the data compression/decompression block 9.

The YUV data for one frame stored in the built-in memory 14 during still image capture is encoded after data compression with the JPEG method and the like by the data compression/decompression block 9. The encoded data is made to a file by the built-in memory 14, is then recorded as still image data in the recording medium 20 serving as image recording means of the present invention via the medium controller 10.

The data compression/decompression block 9 decompresses the data of the still image or moving image read from the recording medium 20 during reproduction of the still image or the moving image, and expands the data in the built-in memory 14 as the still image data or frame data. The expanded image is transferred to the display controller 11 where the image is converted to the video signal, and is then displayed on the LCD 12 as the reproduction image.

On the LCD 12, not only the through image or the reproduction image, but a menu screen or a set-up screen for selection or set-up is also displayed, if necessary, when selecting or setting various functions of the digital camera.

An audio processing block 15 converts the audio input to the microphone 16 embedded in the camera main body 1 during movie capture to a digital signal, and transfers the same to the built-in memory 14 as the audio data after data compression. The audio data transferred to the built-in memory 14 is sequentially stored in the recording medium 20 as stream data along with the frame data. The audio processing block 15 decodes the audio data transferred from the built-in memory 14 during reproduction of the moving image and converted to an analog audio signal, and is then audio-output from the built-in speaker 17 embedded in the camera main body 1.

A key input block 18 includes a plurality of operation keys such as, a shutter button, a power key, a menu key, and a set key, and the key input signal corresponding to the key operation by the user is output to the CPU 13. The shutter button functions as a recording start/end button in the usual movie capture, and functions as capture instructing means of the present invention in the PAST movie capture mode.

Each of the above blocks is controlled by the CPU 13, and the program or data necessary for the CPU 13 to control each block is stored in the program memory 19. The CPU 13 is operated based on the above program and the key input signal to function as capturing time specifying means, setting means, specifying means, calculating means, capture instructing means, capture control means, image file generating means, recording control means, and control means.

The program memory 19 includes a re-writable non-volatile memory such as EEPROM or flash memory, and stores, as necessary, system or set-up data relating to each function set by the user, for example, PAST capturing time and FUTURE capturing time (first capturing time, second capturing time of the present invention) to be hereinafter described used in the PAST movie capture mode, other than the program and data.

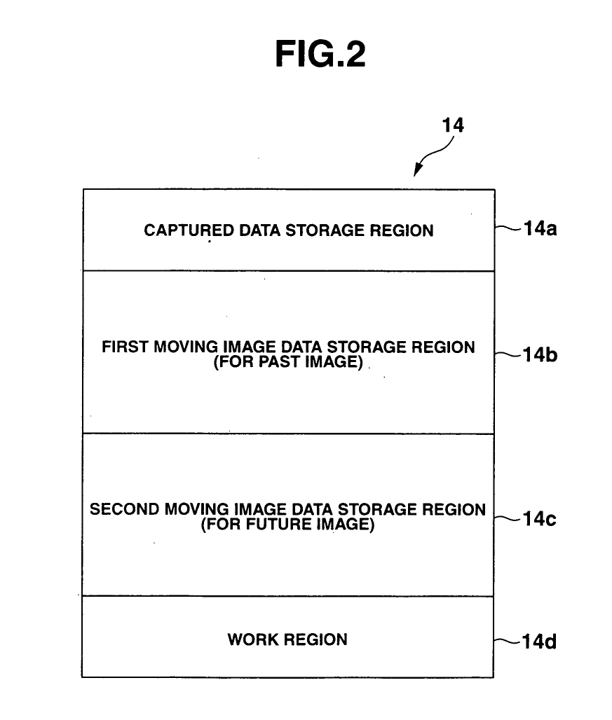

When the PAST movie capture mode is set, a captured data storage region 14a, first and second moving image data storage regions (for PAST and FUTURE movies) 14b and 14c, and other working region 14d are set in the built-in memory 14 (refer to FIG. 2). The captured data storage region 14a is a region whose size is fixedly determined in advance and in which the image data captured by the CCD 3 and transferred from the DSP unit 6 is sequentially stored. The first moving image data storage region 14b is for the PAST image and the second moving image data storage region 14c is for the FUTURE image. The size of each of the regions 14b and 14c is determined by the respective maximum time that can be set as the PAST capturing time (T1) and the FUTURE capturing time (T2), and the frame rate and the image size of the moving image captured in the PAST movie capture mode.

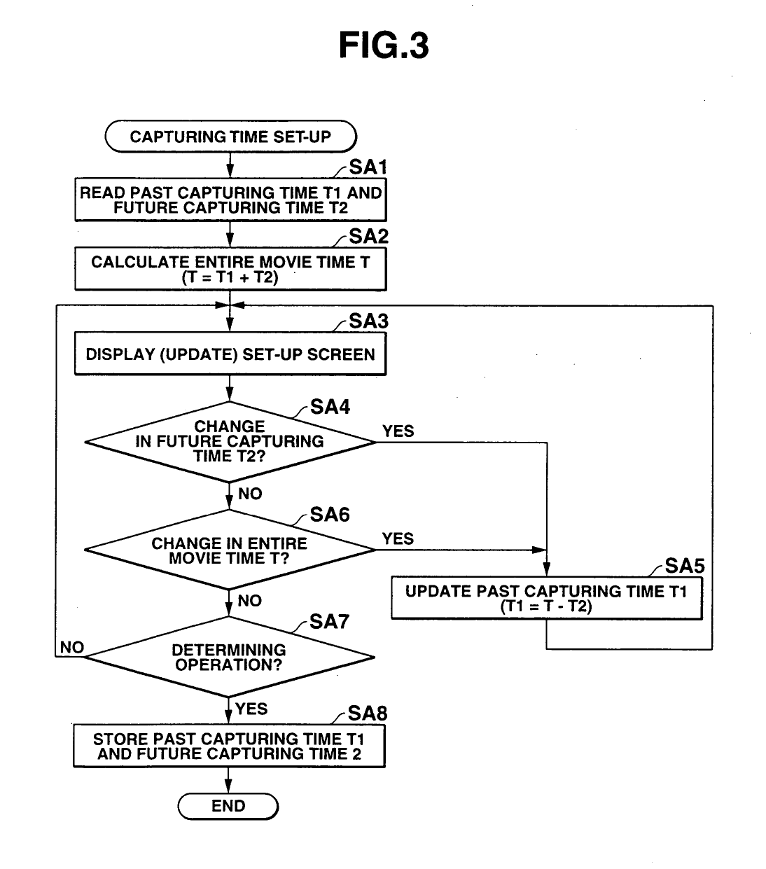

The operation of the digital camera having the above configuration according to the present embodiment will now be explained. FIG. 3 is a flow chart showing the content of the process performed by the CPU 13 when the user sets the capturing time set-up mode provided to set the capturing time during the PAST movie capture mode. The capturing time set-up mode is, in capturing in the PAST movie capture mode, a mode for setting the PAST capturing time acting as the capturing time of the past moving image immediately before the capturing operation is performed by the shutter and the FUTURE capturing time acting as the capturing time of the future moving image after the capturing operation is performed.

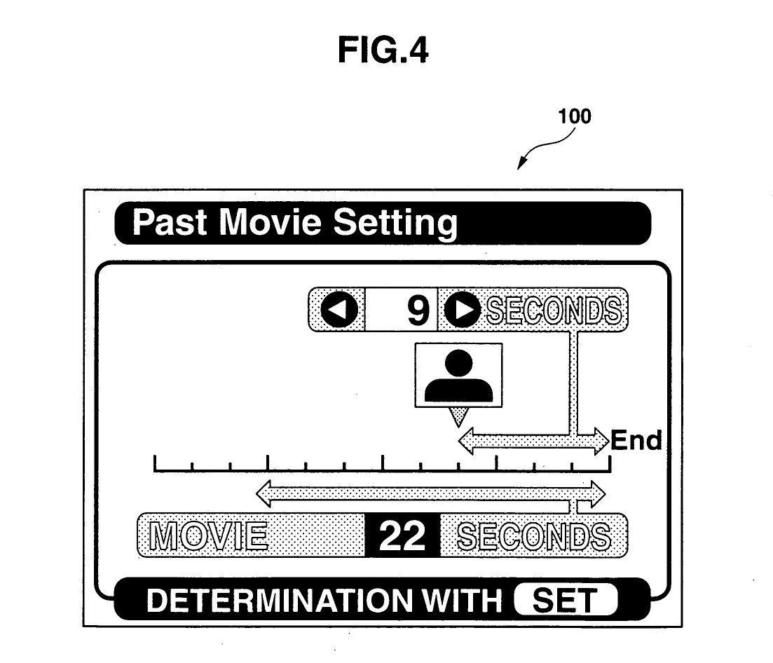

The CPU 13 starts the operation with the setting of the capturing time set-up mode, reads from the program memory 19 the data for the PAST capturing time T1 and the FUTURE capturing time T2 noted above set at that point (step SA1) (a default value is read at an initial state), and calculates the entire movie time T which is the total time of the PAST capturing time T1 and the FUTURE capturing time T2 (step SA2). Thereafter, a capturing time set-up screen 100 shown in FIG. 4 is displayed on the LCD 12 (step SA3). The capturing time set-up screen 100 visually shows the relationship among the entire movie time T, the PAST capturing time T1 and the FUTURE capturing time T2, and the capturing operation timing that are currently being set, and prompts the operation of changing the entire movie time T and the FUTURE capturing time T2. The example shown is an example in which the PAST capturing time T1 at the time is set to “13 sec”, the FUTURE capturing time T2 is set to “9 sec” and the entire movie time T is set to “22 sec”. When changing the FUTURE capturing time T2, the time can be set between “0” and the entire movie time T.

When the FUTURE capturing time T2 is changed (increased/decreased) by the user with a predetermined key operation (YES in step SA4), a new PAST capturing time T1 is calculated from the changed FUTURE capturing time T2 and the entire movie time T (step SA5), and the capturing time set-up screen 100 is updated and displayed (step SA3). When the entire movie time T is changed by the user with a predetermined key operation (YES in step SA6), a new PAST capturing time T1 is also calculated from the changed entire movie time T and the FUTURE capturing time T2 with the FUTURE capturing time T2 as the reference (step SA5), and the capturing time set-up screen 100 is updated and displayed (step SA3).

Until the determining operation by the user is performed (NO in step SA7), the processes of steps SA3 to SA7 are repeated. That is, the user directly sets the entire movie time T and the FUTURE capturing time T2 and indirectly sets the PAST capturing time T1. After the determining operation (set key operation) by the user is performed (YES in step SA7), the data of the PAST capturing time T1 and the FUTURE capturing time T2 stored in the program memory 19 are updated to the data of the new PAST capturing time T1 and the FUTURE capturing time T2 set (changed) through the above-described processes (step SA8), and the operation by the capturing time set-up mode is terminated.

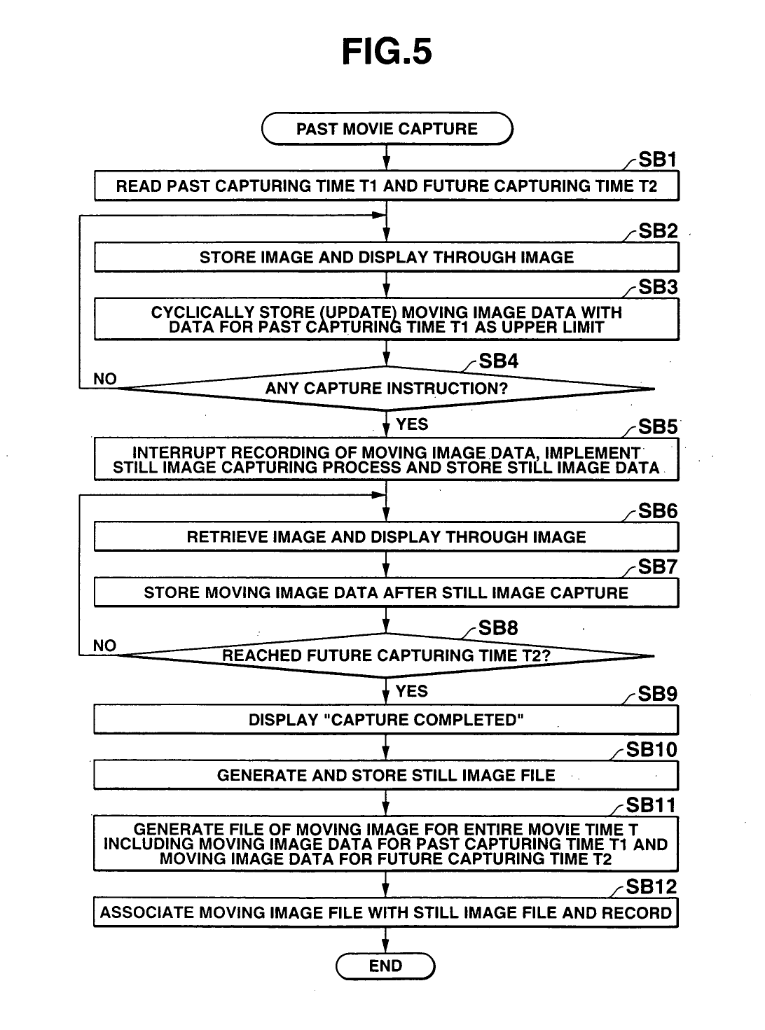

FIG. 5 is a flow chart showing the content of the process performed by the CPU 13 when the PAST movie capture mode is set as the capture mode by the user.

The CPU 13 starts the operation with the setting of the PAST movie capture mode, reads from the program memory 19 the above-described PAST capturing time T1 and FUTURE capturing time T2 set at that point (step SB1), drives the CCD 3 at a period (rate of greater than or equal to the frame rate of at least the PAST movie) corresponding to the frame rate of the moving image (hereinafter referred to as the PAST movie) captured in the PAST movie capture mode, stores the subject image to the first captured data storage region 14a of the built-in memory 14, and starts the display of the through image on the LCD 12 (step SB2). The still image data of a size for the PAST movie is generated from the data of the subject image retrieved to the first captured data storage region 14a, and is stored in the first moving image data storage region 14b of the built-in memory 14 as the moving image data for the PAST capturing time T1 (step SB3). Thereafter, until the capturing operation is performed by the shutter key (NO in step SB4), the processes of steps SB2 and SB3 are repeated, and the generation and storage of the moving image data are continued while updating and displaying the through image. It is to be noted that in step SB3, the moving image data is cyclically stored with the data for PAST capturing time T1 as the upper limit. That is, once the data for the PAST capturing time T1 is stored, the process of erasing the oldest data and storing the new moving image data is repeated.

When the capturing operation is performed by the user or capture instruction is performed with the self-timer while repeating the above processes (YES in step SB4), storage of the moving image data is interrupted, the drive of the CCD 3 is changed for still image capture to perform the usual still image capturing process, and the captured still image data is stored in the work region 14d of the built-in memory 14 (step SB5). Subsequently, the drive period of the CCD 3 is changed to the period corresponding to the frame rate of the moving image, the subject image is retrieved to the captured data storage region 14a of the built-in memory 14, and the display of the through image on the LCD 12 is resumed (step SB6). Thereafter, the still image data of a size for the PAST movie is generated from the data of the subject image stored in the captured data storage region 14a, and is stored in the second moving image data storage region 14c of the built-in memory 14 as the moving image data for the FUTURE capturing time T2 (step SB7). The elapsed time from the point (point of capture instruction etc.) the storage of the moving image data is resumed is counted by a timer function of an internal clock, and the processes of steps SB6 and SB7 are repeated until the time reaches the FUTURE capturing time T2 (NO in step SB8). The generation and storage of the moving image data are continued while updating and displaying the through image.

When the elapsed time from the point the storage of the moving image data is resumed has reached the FUTURE capturing time T2 (YES in step SB8), the movie capture is terminated at that point, and “Capture Completed” is displayed on the LCD 12 (step SB9). The still image data stored in the work region 14d of the built-in memory 14 is compressed, predetermined additional information is added thereto and the still image file is created in the built-in memory 14, and recorded in the recording medium (step SB10). The moving image of the entire movie time T is compressed, the moving image including the moving image data for the PAST capturing time T1 and the moving image data for the FUTURE capturing time T2 which are stored in the first and second moving image data storage regions 14b and 14c of the built-in memory 14. Predetermined additional information is added thereto and the moving image file is created in the built-in memory 14 (step SB11). Thereafter, the created moving image file is associated with the previously recorded still image file and recorded in the recording medium 20 (step SB12). The still image file and the moving image file may be associated with each other by an arbitrary method, and when, for example, an extension (“.mpg” for MPEG etc.) indicating the type of file is included in the file name, the file name excluding the extension is matched. The operation by the PAST movie capture mode is thereby terminated.

In capturing with the PAST movie capture mode, as described above, only one capturing operation makes it possible to capture and record the moving image composed of a plurality of frames of still image of the subject at the time around the capturing operation. With regards to the moving image to be captured, the capturing time, that is, the PAST capturing time T1 and the FUTURE capturing time T2 are set in advance by the capturing time set-up mode. Therefore, the intended moving image is captured without missing the intended moment before the start or after the termination of the movie capture, that is, missing the moment the user expected to take before capturing. Further, if the PAST capturing time T1 and the FUTURE capturing time T2 are made to the minimum, the next capturing timing is not affected. That is, the opportunity for the next still image capture or movie capture will not be missed.

When setting the PAST capturing time T1 and the FUTURE capturing time T2 at the above-mentioned capturing time set-up mode, the allocation of the PAST capturing time T1 and the FUTURE capturing time T2 with respect to the entire movie time T is easily set, and thus is easy to use. Further, since the captured still image file and the captured moving image file are associated with each other and recorded in the recording medium 20, the distinguishing work of the moving image and the still image taken during the same period of time becomes easy after capture, and thus is easy to use.

An example of using the PAST movie capture mode explained above includes taking a group photo of a ceremonial photograph and the like in the PAST movie capture mode. In this case, the moving image including the scene in which there is tension before the ceremonial photograph and the scene in which there are murmurs after taking the ceremonial photograph (scene often seen after the ceremonial photograph where someone says “Oh! I closed my eyes!”) is taken.

In the present embodiment, the entire movie time T and the FUTURE capturing time T2 are specified by the user in the capturing time set-up mode, but the entire movie time T and the PAST capturing time T1 may be specified. When the PAST movie capture mode is set, the mode may be temporarily changed to the capturing time set-up mode through a predetermined key operation so that the PAST capturing time T1 or the FUTURE capturing time T2 is specified.

In the PAST movie capture mode, the still image capture is performed simultaneously with the movie capture, but is not limited thereto, and only the movie capture may be performed in the PAST movie capture mode. Further, the user may set whether to perform the still image capture simultaneously with the movie capture, as necessary.

### Second Embodiment

A second embodiment of the present invention will now be explained. The second embodiment has, in the digital camera having the configuration shown in FIG. 1, the above mentioned program memory 19 stores therein the program for functioning the CPU 13 as the specifying means, the setting means, the termination instructing means, the specifying means, the capture instructing means, the capture control means, the image file generating means, the recording control means and the control means. The CPU 13 implements the processes to be hereinafter described when set to the PAST movie capture mode. In this embodiment, the above-mentioned capturing time set-up mode is not provided. Similar to the first embodiment, the first moving image data storage region 14b is for the PAST image, and the size thereof is determined by the respective maximum time that can be set as the PAST capturing time T1 and the frame rate as well as the image size of the moving image captured in the PAST movie capture mode.

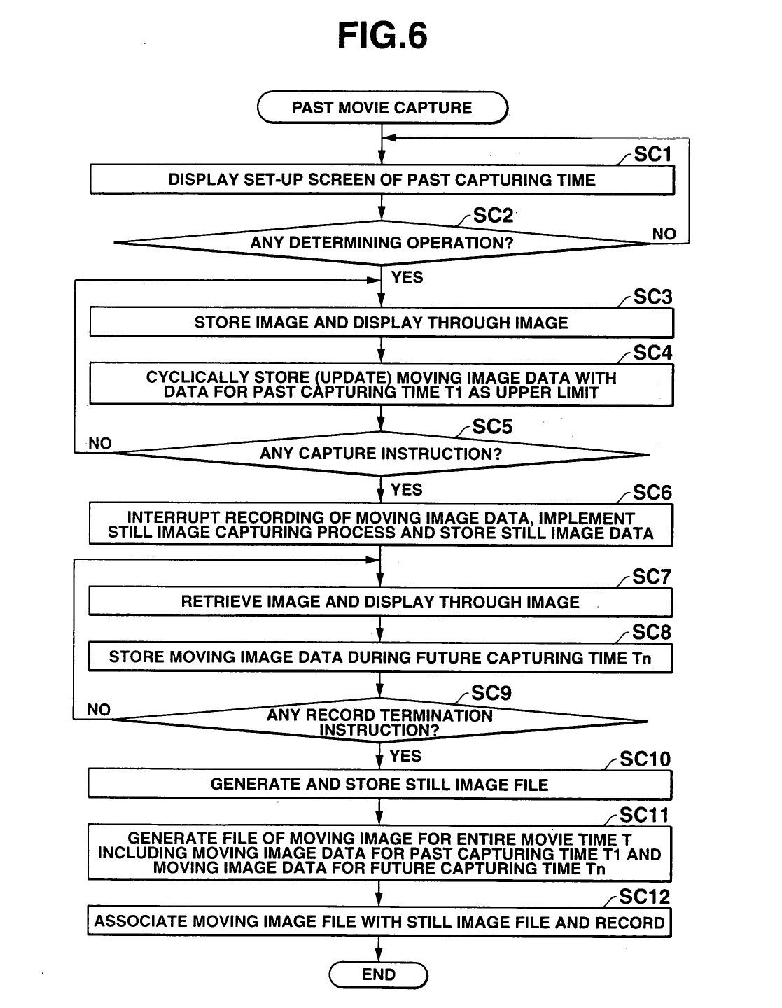

FIG. 6 is a flow chart showing the content of the process performed by the CPU 13 when the PAST movie capture mode is set as the capture mode by the user.

The CPU 13 starts the operation with the setting of the PAST movie capture mode, and first displays the set-up screen of the PAST capturing time is displayed on the LCD 12, the PAST capturing time being the capturing time of the past moving image immediately before the capturing operation is performed by the shutter, and allows the user to set the PAST capturing time (step SC1). Although not shown, the set-up screen displayed at this point only shows the PAST capturing time, and the PAST capturing time of the set-up screen is changed (increased/decreased) in accordance with a predetermined operation by the user while the set-up screen is displayed. Until the determination operation is performed by the user (NO in step SC2), the display of the set-up screen and the change of the PAST capturing time in accordance with the operation of the user are continuously performed.

Subsequently, when the determination operation is performed by the user (YES in step SC2), the CCD 3 is driven at a period (rate of greater than or equal to the frame rate of the PAST movie) corresponding to the frame rate of the PAST movie, the subject image is stored in the first captured data storage region 14a of the built-in memory 14, and the display of the through image on the LCD 12 is started (step SC3). The still image data of the size of the PAST movie is generated from the data of the subject image stored in the first captured data storage region 14a, and is stored in the first moving image data storage region 14b of the built-in memory 14 as the moving image data for the PAST capturing time T1 (step SC4). Thereafter, the processes of steps SC3 and SC4 are repeated until the capturing operation by the shutter key (NO in step SC5), and the generation and storage of the moving image data are continued while updating and displaying the through image. It is to be noted that in step SC4, similar to the first embodiment, the moving image data is cyclically stored with the data for the PAST capturing time T1 as the upper limit.

When the capturing operation is performed by the user (YES in step SC5) while repeating the above processes, the storage of the moving image data is interrupted, the drive of the CCD 3 is changed for still image capture to perform the usual still image capturing process, and the captured still image data is stored in the work region 14d of the built-in memory 14 (step SC6). Subsequently, the drive period of the CCD 3 is changed to the period corresponding to the frame rate of the moving image, the subject image is stored in the captured data storage region 14a of the built-in memory 14, and the display of the through image at the LCD 12 is resumed (step SC7). Thereafter, the still image data of a size for the PAST movie is generated from the data of the subject image stored in the captured data storage region 14a, and is stored in the second moving image data storage region 14c of the built-in memory 14 as the moving image data for the time FUTURE capturing time Tn until the record terminating instruction is provided through the operation of the shutter key by the user (step SC8). Until the record terminating instruction is provided through the operation of the shutter key by the user (NO in step SC9), the processes of steps SC7 and SC8 are repeated, and the generation and storage of the moving image data are continued.

When the record terminating instruction is provided (YES in step SC9), the movie capture is terminated at that point, the still image data stored in the work region 14d of the built-in memory 14 is compressed, predetermined additional information is added thereto and the still image file is created, and recorded in the recording medium (step SC10). The moving image of the entire movie time T is compressed, the moving image including the moving image data for the PAST capturing time T1 and the moving image data for the FUTURE capturing time T2 which are stored in the first and second moving image data storage regions 14b and 14c of the built-in memory 14. Predetermined additional information is added thereto, and the file of the moving image is created (step SC11). Thereafter, the created moving image file is associated with the previously recorded still image file and recorded in the recording medium 20 (step SC12). The still image file and the moving image file may be associated with each other by an arbitrary method, and when, for example, an extension (“.mpg” for MPEG etc.) indicating the type of file is included in the file name, the file name excluding the extension is matched. The operation by the PAST movie capture mode is thereby terminated.

In the present embodiment, with regards to capturing in the PAST movie capture mode, the user is able to set the PAST capturing time T1 prior to capturing and the termination timing of the movie capture is suitably determined after the start of the movie capture. Therefore, in the embodiment as well, the intended moving image is captured without missing the intended moment before the start or after the termination of the movie capture, that is, missing the moment the user expected to take before capturing. Further, if the PAST capturing time T1 and the FUTURE capturing time T2 are made to the minimum, the next capturing timing is not affected. That is, the opportunity for the next still image capture or movie capture will not be missed. Moreover, the still image capture is performed when the capturing operation is first performed.

Since the captured still image file and the captured moving image file are associated with respect to each other and recorded in the recording medium 20, the distinguishing work of the moving image and the still image taken at the same time becomes easy after capturing and thus is easy to use.

Compared to the first embodiment, since the termination timing of the movie capture is suitably determined after the start of the movie capture, missing the moment after the termination of the moving image is reliably prevented. Therefore, by using the PAST movie capture mode described above, the “crucial timing of a goal scene and the like of a soccer game” etc. is recorded as the still image, and the “expression and reaction (victory pose etc.) of the player” thereafter can be taken without missing.

In the embodiment, the capturing time set-up mode for setting the PAST capturing time T1 is not particularly provided, but such a capturing time set-up mode may be separately provided. Further, when the above PAST movie capture mode is set, the mode is temporarily changed to the capturing time set-up mode with a predetermined key operation so that the PAST capturing time T1 is specified.

In the embodiment, the still image capture is performed simultaneously with the movie capture in the PAST movie capture mode, but is not limited thereto, and only the movie capture may be performed in the PAST movie capture mode. Further, the user is able to set whether or not perform the still image capture simultaneously with the movie capture, as necessary.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. A camera device comprising:
means for capturing a subject and outputting moving image data;
means for recording the moving image data output from the capturing means;
instructing means for instructing recording of the moving image data output from the capturing means into the recording means;
means for specifying a first capturing time and a second capturing time by manual operation;
first recording control means for, when the instructing means instructs recording, recording first moving image data output from the capturing means into the recording means during the first capturing time specified by the specifying means immediately before the recording instructing means instructs recording; and
second recording control means for, when the instructing means instructs recording, recording second moving image data output from the capturing means into the recording means during the second capturing time specified by the specifying means immediately after the instructing means instructs recording.

2. The camera device according to claim 1, wherein
the specifying means includes means for setting the first capturing time and the second capturing time in advance before the instructing means instructs recording,
the first recording control means, when the instructing means instructs recording, records first moving image data output from the capturing means into the recording means during the first capturing time set by the setting means immediately before the instructing means instructs recording, and
the second recording control means, when the instructing means instructs recording, records second moving image data output from the capturing means into the recording means during the second capturing time set by the setting means immediately after the instructing means instructs recording.

3. The camera device according to claim 2, wherein
the setting means includes:
means for specifying a total capturing time of the first and second capturing times, and the second capturing time; and
means for calculating the first capturing time based on the total capturing time and the second capturing time specified by the specifying means, and
the setting means sets the first capturing time calculated by the calculating means and the second capturing time specified by the specifying means.

4. The camera device according to claim 2, wherein the setting means includes:
means for specifying a total capturing time of the first and second capturing times, and the first capturing time; and
means for calculating the second capturing time based on the total capturing time and the first capturing time specified by the specifying means, and
the setting means sets the first capturing time specified by the specifying means and the second capturing time calculated by the calculating means.

5. The camera device according to claim 1, wherein
the specifying means includes means for setting the first capturing time in advance before the instructing means instructs recording, and termination instructing means for instructing termination of recording of the moving image data output from the capturing means into the recording means,
the first recording control means, when the instructing means instructs recording, records first moving image data output from the capturing means into the recording means during the first capturing time set by the setting means immediately before the instructing means instructs recording, and
the second recording control means, when the instructing means instructs recording, records moving image data output from the capturing means into the recording means after the instructing means instructs recording, and, when the termination instructing means instructs termination of recording of the moving image data during recording operation, terminates recording of the moving image data.

6. The camera device according to claim 5, further comprising temporary storage means for sequentially and cyclically storing the moving image data output from the capturing means for a predetermined time, and wherein
the first recording control means, when the instructing means instructs recording, records the first moving image data already stored in the temporary storage means into the recording means.

7. The camera device according to claim 6, wherein the temporary storage means sequentially and cyclically stores the moving image data output from the capturing means for the first capturing time.

8. The camera device according to claim 1, further comprising means for generating a moving image file including the first moving image data and the second moving image data output from the capturing means, and wherein
the first and second recording control means record the moving image file generated by the generating means into the recording means.

9. The camera device according to claim 1, wherein the capturing means includes means for outputting still image data, further comprising
capture control means for, when the instructing means instructs recording, stopping output of the moving image data from the capturing means, causing the capturing means to output the still image data, and resuming output of the moving image data from the capturing means.

10. The camera device according to claim 9, further comprising third recording control means for, when the instructing means instructs recording, recording the still image data output from the capturing means by the capture control means into the recording means.

11. The camera device according to claim 10, wherein
the capture control means includes still image file generating means for generating a still image file including the still image data output from the capturing means by the capture control means, and
the third recording control means records the still image file generated by the still image file generating means into the recording means.

12. The camera device according to claim 11, further comprising moving image file generating means for generating a moving image file including the first moving image data and the second moving image data output from the capturing means, and wherein
the first and second recording control means record the moving image file generated by the moving image file generating means into the recording means.

13. The camera device according to claim 12, wherein the first, second, and third recording control means associate the still image file and the moving image file with each other and record the files into the recording means.

14. A method of capturing moving image data in a camera device comprising a capturing unit which captures a subject and outputs moving image data and a recording unit which records the moving image data output from the capturing unit, the method comprising the steps of:
specifying a first capturing time and a second capturing time by manual operation;
instructing recording of the moving image data output from the capturing unit into the recording unit; and
when recording is instructed, recording first moving image data output from the capturing unit into the recording unit during the first capturing time immediately before the recording is instructed and recording second moving image data output from the capturing unit into the recording unit during the second capturing time immediately after the recording is instructed.

15. A program for causing a computer of a camera device comprising a capturing unit which captures a subject and outputs moving image data and a recording unit which records the moving image data output from the capturing unit, the program causing the computer to execute processings of:
specifying a first capturing time and a second capturing time by manual operation;
instructing recording of the moving image data output from the capturing unit into the recording unit;
when recording is instructed, recording first moving image data output from the capturing unit into the recording unit during the first capturing time immediately before the recording is instructed; and
when recording is instructed, recording second moving image data output from the capturing unit into the recording unit during the second capturing time immediately after the recording is instructed.
